(19) United States
(12) Patent Application Publication
(10) Pub. No.: US 2024/0140456 A1
(43) Pub. Date: May 2, 2024

(54) METHOD AND SYSTEM FOR VEHICLE PERFORMANCE CONTROL

(71) Applicant: Dana Heavy Vehicle Systems Group, LLC, Maumee, OH (US)

(72) Inventors: Abhijeet BHOPTE, Ann Arbor, MI (US); Gordon PETERSON, Sylvania, OH (US)

(21) Appl. No.: 18/051,784

(22) Filed: Nov. 1, 2022

(51) Int. Cl. B60W 50/10; B60W 10/08; B60W 30/182

(52) U.S. Cl. CPC B60W 50/10; B60W 10/08; B60W 30/182; B60W 2540/10; B60W 2540/12; B60W 2710/083

(57) ABSTRACT

Methods and systems for managing performance of a vehicle are described. The methods and systems may compare present vehicle performance to one of a plurality of predetermined performance levels to control the vehicle's present level of performance. The methods and systems may correct torque output of a propulsion source according to the comparison.

### TECHNICAL FIELD

The present disclosure relates to a method and system for controlling performance of a vehicle. The method may be applied to an electric vehicle that includes an electrified axle.

### BACKGROUND AND SUMMARY

A vehicle may respond to a driver demand pedal position. For example, for a given driver demand pedal position, a torque request of 200 Newton-meters may be generated. The torque may then be delivered by an engine or an electric machine. The driver that applies the driver demand pedal may operate as a controller to adjust vehicle speed and a rate that vehicle speed increases. While this arrangement may be effective, it may also be noticeable to the driver that the driver may have to adjust the driver demand pedal position differently under some situations to achieve a same level of vehicle performance. In particular, if the vehicle goes from an unloaded state to a loaded state by adding 500 kilograms of mass to the vehicle, the driver may have to increase an amount that the driver demand pedal is depressed or applied to maintain a requested or desired rate of vehicle speed change. As such, the vehicle driver may notice a substantial change in vehicle performance relative to driver demand pedal position. Additionally, an owner of the vehicle may not wish for a driver to have authority over a complete torque output range of a powertrain. For example, the owner of the vehicle may wish to limit torque output of a powertrain to so that energy to operate the vehicle may be conserved. As such, there may be times when it may be desirable to go beyond a system that maps a driver demand pedal position to torque output of a powertrain.

The inventors herein have recognized the above-mentioned issues and have developed a vehicle system, comprising: a propulsion source; a driver demand pedal; and a controller including executable instructions that cause the controller to adjust a torque request in response to a difference between output of one of a plurality of performance profiles and a present rate of vehicle speed change.

By adjusting a torque in response to a difference between output of one of a plurality of performance profiles and a present rate of vehicle speed change, it may be possible to provide the technical result of a vehicle that performs similarly whether the vehicle is operating on a flat road or traveling up an incline. Further, the approach may be applied to vehicle regenerative braking so that regenerative braking may be more repeatable.

The present description may provide several advantages. In particular, the approach may allow vehicle performance to be more consistent. In addition, the approach may provide more consistent vehicle operation between different vehicle drivers. Further, the approach may allow a vehicle owner to control vehicle performance so that vehicle fuel economy may be made more consistent even with different vehicle drivers.

It is to be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is an illustration of an example vehicle that includes an electrified axle.

FIGS. 2A and 2B show example vehicle performance profiles according to the methods of FIGS. 5 and 6.

FIG. 3 shows prior art vehicle performance profiles.

FIG. 4 shows vehicle performance profiles according to the method of FIG. 5.

FIGS. 5 and 6 show flowcharts of methods to operate a vehicle.

FIGS. 7 and 8 show block diagrams of vehicle controllers.

### DETAILED DESCRIPTION

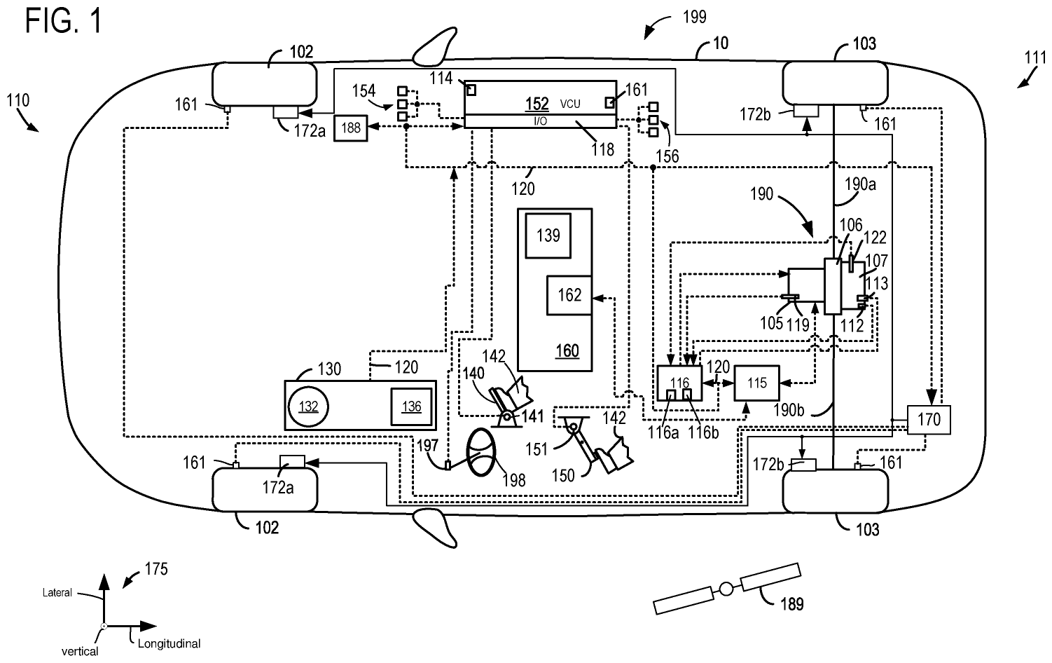

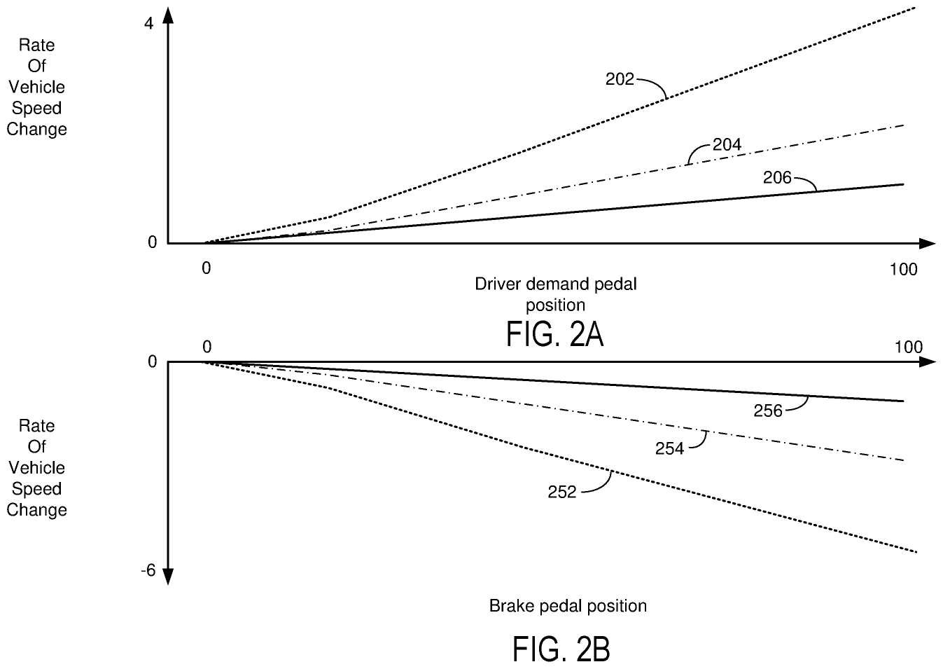

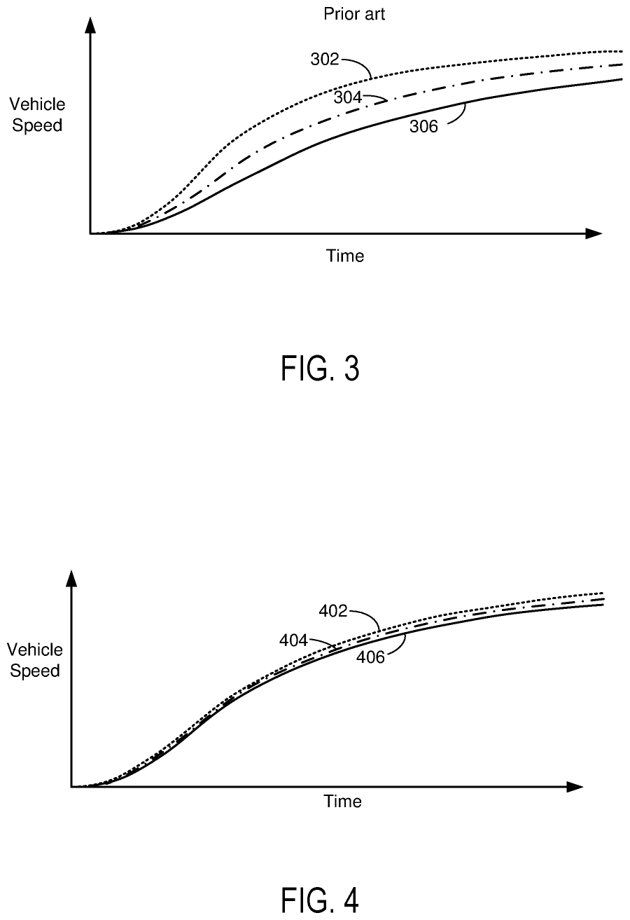

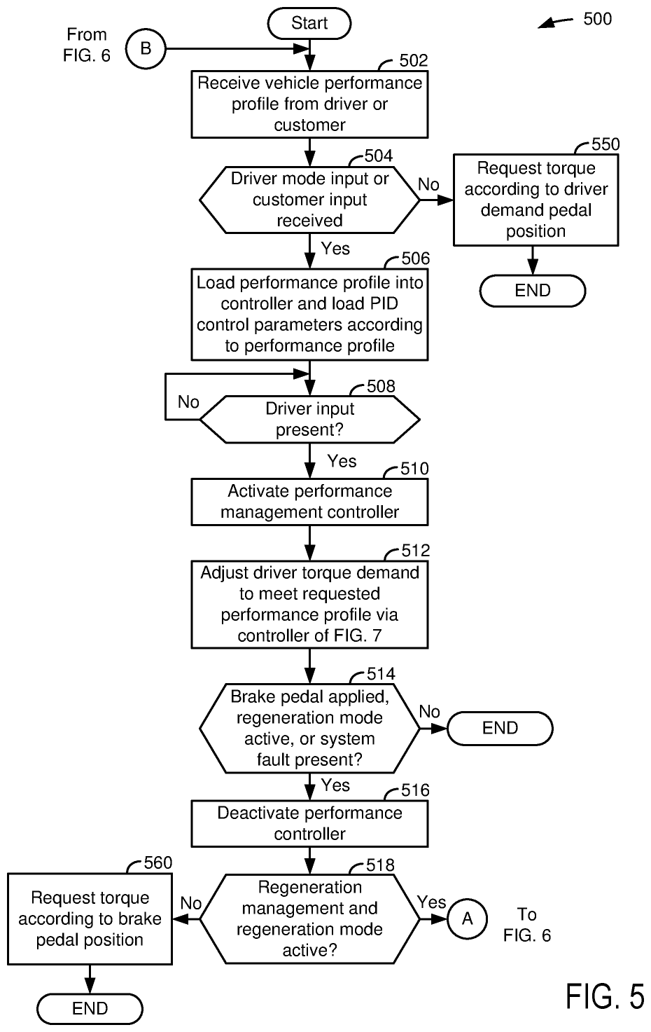

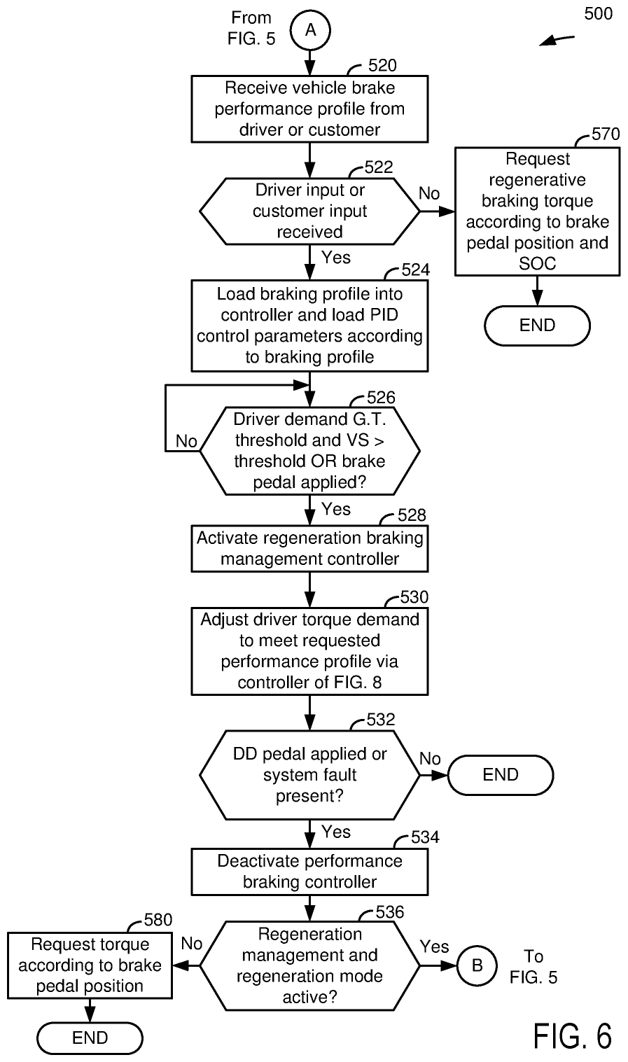

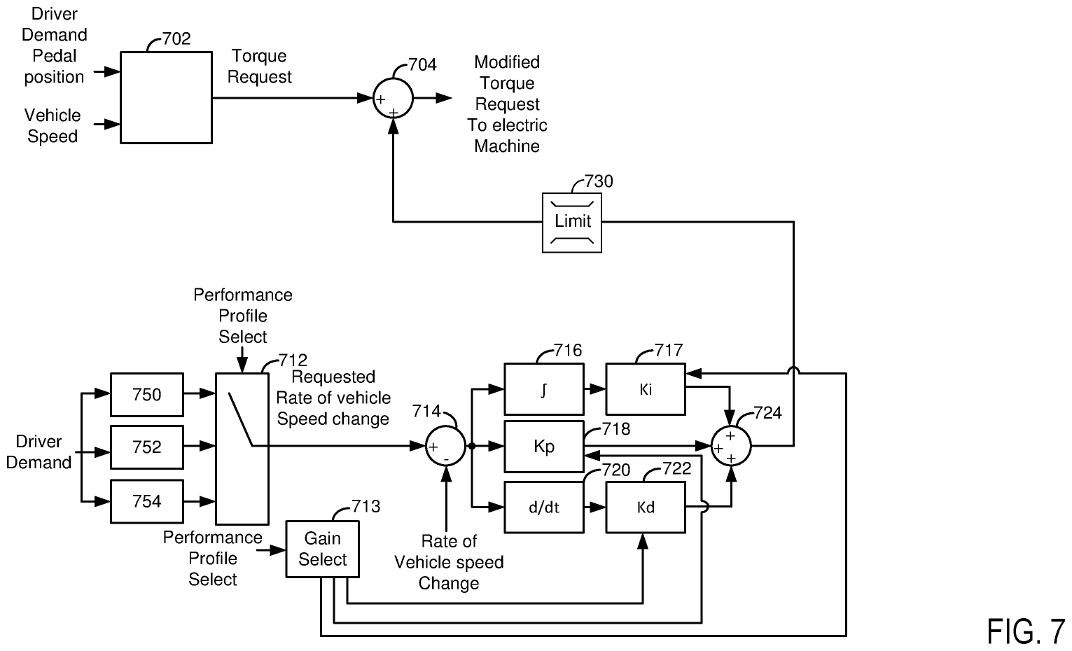

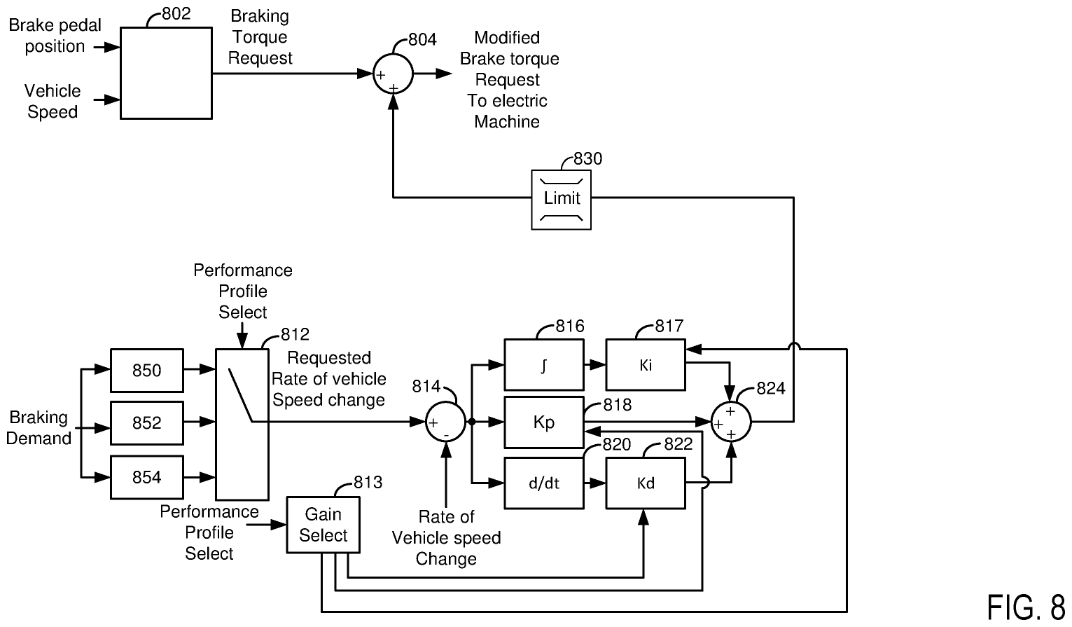

A method and system for operating a vehicle is described. The method and system are suitable for vehicles that include electric, hybrid, or internal combustion engine propulsion sources. The method and system compare a present vehicle rate of speed change with a predetermined vehicle profile. If the vehicle's propulsion source is providing torque that may be less than sufficient to meet the predetermined vehicle profile, the requested propulsion torque may be increased so that the vehicle may meet the predetermined vehicle performance. The approach may be particularly suited for electric vehicles. One example electric vehicle is shown in FIG. 1; however, it may be appreciated that the approach described herein is applicable to alternatively configured electric vehicles, hybrid vehicles, and vehicles that are propelled solely via an internal combustion engine. FIGS. 2A and 2B show example vehicle performance profiles for applying a driver demand pedal or a brake pedal. FIG. 3 shows an example vehicle speed profile for prior art vehicles. FIG. 4 shows an example vehicle speed profile according to the present method. FIGS. 5 and 6 show flowcharts of example methods for operating a vehicle. FIGS. 7 and 8 show block diagrams of example vehicle controllers.

FIG. 1 illustrates an example vehicle propulsion system 199 for vehicle 10. A front end 110 of vehicle 10 is indicated and a rear end 111 of vehicle 10 is also indicated. Vehicle 10 travels in a forward direction when front end leads movement of vehicle 10. Vehicle 10 travels in a reverse direction when rear end leads movement of vehicle 10. Vehicle propulsion system 199 includes a propulsion source 105 (e.g., an electric machine), but in other examples two or more propulsion sources may be provided. In one example, propulsion source 105 may be an electric machine that operates as a motor or generator. The propulsion source 105 is fastened to the electrified axle 190. In FIG. 1 mechanical connections between the various components are illustrated as solid lines, whereas electrical connections between various components are illustrated as dashed lines.

Vehicle propulsion system 199 includes an electrified axle 190 (e.g., an axle that includes an integrated electric machine that provides propulsive effort for the vehicle). Electrified axle 190 may include two half shafts, including a first or right haft shaft 190a and a second or left half shaft 190b. Vehicle 10 further includes front wheels 102 and rear wheels 103.

The electrified axle 190 may be an integrated axle that includes differential gears 106, gear set 107, and propulsion source 105. Electrified axle 190 may include a first speed sensor 119 for sensing a speed of propulsion source 105, a second speed sensor 122 for sensing a speed of an output shaft (not shown), a first clutch actuator 112, and a clutch position sensor 113. Electric power inverter 115 is electrically coupled to propulsion source 105. An axle control unit 116 is electrically coupled to sensors and actuators of electrified axle 190.

Propulsion source 105 may transfer mechanical power to or receive mechanical power from gear set 107. As such, gear set 107 may be a multi-speed gear set that may shift between gears when commanded via axle control unit 116. Axle control unit 116 includes a processor 116a and memory 116b. Memory 116b may include read only memory, random access memory, and keep alive memory. Gear set 107 may transfer mechanical power to or receive mechanical power from differential gears 106. Differential gears 106 may transfer mechanical power to or receive mechanical power from rear wheels 103 via right half shaft 190a and left half shaft 190b. Propulsion source 105 may consume alternating current (AC) electrical power provided via electric power inverter 115. Alternatively, propulsion source 105b may provide AC electrical power to electric power inverter 115. Electric power inverter 115 may be provided with high voltage direct current (DC) power from electric energy storage device 160 (e.g., a traction battery or a traction capacitor). Electric power inverter 115 may convert the DC electrical power from electric energy storage device 160 into AC electrical power for propulsion source 105. Alternatively, electric power inverter 115 may be provided with AC power from propulsion source 105. Electric power inverter 115 may convert the AC electrical power from propulsion source 105 into DC power to store in electric energy storage device 160.

Electric energy storage device 160 may periodically receive electrical energy from a power source such as a stationary power grid (not shown) residing external to the vehicle (e.g., not part of the vehicle). As a non-limiting example, vehicle propulsion system 199 may be configured as a plug-in electric vehicle (EV), whereby electrical energy may be supplied to electric energy storage device 160 via the power grid (not shown).

Electric energy storage device 160 may include an electric energy storage device controller 139 and an electrical power distribution box 162. Electric energy storage device controller 139 may provide charge balancing between energy storage element (e.g., battery cells) and communication with other vehicle controllers (e.g., vehicle control unit 152).

Vehicle 10 may include a vehicle control unit (VCU) controller 152 that may communicate with electric power inverter 115, axle control unit 116, friction or foundation brake controller 170, global positioning system (GPS) 188, and dashboard 130 and components included therein via controller area network (CAN) 120. VCU 152 includes memory 114, which may include read-only memory (ROM or non-transitory memory) and random access memory (RAM). VCU also includes a digital processor or central processing unit (CPU) 161, and inputs and outputs (I/O) 118 (e.g., digital inputs including counters, timers, and discrete inputs, digital outputs, analog inputs, and analog outputs). VCU may receive signals from sensors 154 and provide control signal outputs to actuators 156. Sensors 154 may include but are not limited to lateral accelerometers, longitudinal accelerometers, yaw rate sensors, inclinometers, temperature sensors, electric energy storage device voltage and current sensors, and other sensors described herein. Additionally, sensors 154 may include steering angle sensor 197, driver demand pedal position sensor 141, vehicle range finding sensors including radio detection and ranging (RADAR), light detection and ranging (LIDAR), sound navigation and ranging (SONAR), and brake pedal position sensor 151. Actuators may include but are not constrained to inverters, transmission controllers, display devices, human/machine interfaces, friction braking systems, and electric energy storage device controller described herein.

Driver demand pedal position sensor 141 is shown coupled to driver demand pedal 140 for determining a degree of application of driver demand pedal 140 by human 142. Brake pedal position sensor 151 is shown coupled to brake pedal 150 for determining a degree of application of brake pedal 150 by human 142. Steering angle sensor 197 is configured to determine a steering angle according to a position of steering wheel 198.

Vehicle propulsion system 199 is shown with a global position determining system 188 that receives timing and position data from one or more GPS satellites 189. Global positioning system may also include geographical maps in ROM for determining the position of vehicle 10 and features of roads that vehicle 10 may travel on.

Vehicle propulsion system may also include a dashboard 130 that an operator of the vehicle may interact with. Dashboard 130 may include a display system 132 configured to display information to the vehicle operator. Display system 132 may comprise, as a non-limiting example, a touchscreen, or human machine interface (HMI), display which enables the vehicle operator to view graphical information as well as input commands. In some examples, display system 132 may be connected wirelessly to the internet (not shown) via VCU 152. As such, in some examples, the vehicle operator may communicate via display system 132 with an internet site or software application (app) and VCU 152.

Dashboard 130 may further include an operator interface 136 via which the vehicle operator may adjust the operating status of the vehicle. Specifically, the operator interface 136 may be configured to activate and/or deactivate operation of the vehicle driveline (e.g., propulsion source 105) based on an operator input. Further, an operator may request an axle mode (e.g., park, reverse, neutral, drive) via the operator interface. Various examples of the operator interface 136 may include interfaces that require a physical apparatus, such as a key, that may be inserted into the operator interface 136 to activate the electrified axle 190 and propulsion source 105 and to turn on the vehicle 10 or may be removed to shut down the electrified axle and propulsion source 105 to turn off vehicle 10. Electrified axle 190 and propulsion source 105 may be activated via supplying electric power to propulsion source 105 and/or electric power inverter 115. Electrified axle 190 and electric machine may be deactivated by ceasing to supply electric power to electrified axle 190 and propulsion source 105 and/or electric power inverter 115. Still other examples may additionally or optionally use a start/stop button that is manually pressed by the operator to start or shut down the electrified axle 190 and propulsion source 105 to turn the vehicle on or off. In other examples, a remote electrified axle or electric machine start may be initiated remote computing device (not shown), for example a cellular telephone, or smartphone-based system where a user's cellular telephone sends data to a server and the server communicates with the vehicle controller 152 to activate the electrified axle 190 including an inverter and electric machine. Spatial orientation of vehicle 10 is indicated via axes 175.

Vehicle 10 is also shown with a foundation or friction brake controller 170. Friction brake controller 170 may selectively apply and release friction brakes (e.g., 172a and 172b) via allowing hydraulic fluid to flow to the friction brakes. The friction brakes may be applied and released so as to avoid locking of the friction brakes to front wheels 102 and rear wheels 103. Wheel position or speed sensors 161 may provide wheel speed data to friction brake controller 170. Vehicle propulsion system 199 may provide torque to rear wheels 103 to propel vehicle 10.

A human or autonomous driver may request a driver demand wheel torque, or alternatively a driver demand wheel power, via applying driver demand pedal 140 or via supplying a driver demand wheel torque/power request to vehicle controller 152. Vehicle controller 152 may then demand a torque or power from propulsion source 105 via commanding axle control unit 116. Axle control unit 116 may command electric power inverter 115 to deliver the driver demand wheel torque/power via electrified axle 190 and propulsion source 105. Electric power inverter 115 may convert DC electrical power from electric energy storage device 160 into AC power and supply the AC power to propulsion source 105. Propulsion source 105 rotates and transfers torque/power to gear set 107. Gear set 107 may supply torque from propulsion source 105 to differential gears 106, and differential gears 106 transfer torque from propulsion source 105 to rear wheels 103 via half shafts 190a and 190b.

During conditions when the driver demand pedal is fully released, vehicle controller 152 may request a small negative or regenerative braking power to gradually slow vehicle 10 when a speed of vehicle 10 is greater than a threshold speed. The amount of regenerative braking power requested may be a function of driver demand pedal position, electric energy storage device state of charge (SOC), vehicle speed, and other conditions. If the driver demand pedal 140 is fully released and vehicle speed is less than a threshold speed, vehicle controller 152 may request a small amount of positive torque/power (e.g., propulsion torque) from propulsion source 105, which may be referred to as creep torque or power. The creep torque or power may allow vehicle 10 to remain stationary when vehicle 10 is on a positive grade.

The human or autonomous driver may also request a negative or regenerative driver demand braking torque, or alternatively a driver demand braking power, via applying brake pedal 150 or via supplying a driver demand braking power request to vehicle control unit 152. Vehicle controller 152 may request that a first portion of the driver demanded braking power be generated via electrified axle 190 and propulsion source 105 via commanding axle control unit 116. Additionally, vehicle controller 152 may request that a portion of the driver demanded braking power be provided via friction brakes 172 via commanding friction brake controller 170 to provide a second portion of the driver requested braking power.

After vehicle controller 152 determines the braking power request, vehicle controller 152 may command axle control unit 116 to deliver the portion of the driver demand braking power allocated to electrified axle 190. Electric power inverter 115 may convert AC electrical power generated by propulsion source 105 into DC power for storage in electric energy storage device 160. Propulsion source 105 may convert the vehicle's kinetic energy into AC power.

Axle control unit 116 includes predetermined transmission gear shift schedules whereby fixed ratio gears of gear set 107 may be selectively engaged and disengaged. Shift schedules stored in axle control unit 116 may select gear shift points or conditions as a function of driver demand wheel torque and vehicle speed.

Thus, the system of FIG. 1 provides for a vehicle system, comprising: a propulsion source; a driver demand pedal; and a controller including executable instructions that cause the controller to adjust a torque request in response to a difference between output of one of a plurality of performance profiles and a present rate of vehicle speed change. In a first example, the vehicle system includes wherein the output of one of the plurality of performance profiles is a rate of vehicle speed change. In a second example that may include the first example, the vehicle system includes wherein a torque of the propulsion source is adjusted to meet the torque request, and where the propulsion source is an electric machine. In a third example that may include one or both of the first and second examples, the vehicle system includes wherein the torque request is based on a position of the driver demand pedal. In a fourth example that may include one or more of the first through third examples, the vehicle system includes wherein the torque request is adjusted via a proportional/integral/derivative controller. In a fifth example that may include one or more of the first through fourth examples, the vehicle system further comprises additional instructions to adjust a proportional gain and an integral gain based on one of the plurality of performance profiles. In a sixth example that may include one or more of the first through fifth examples, the vehicle system includes where the propulsion source is integrated in an axle. In a seventh example that may include one or more of the first though sixth examples, the vehicle system includes where the plurality of performance profiles include an economy profile, a baseline profile, and a sport profile.

The system of FIG. 1 also provides for a vehicle system, comprising: a propulsion source; a driver demand pedal; and a controller including executable instructions that cause the controller to adjust a driver demand torque delivered by the propulsion source according to a correction output by a proportional/integral/derivative controller that responds to a vehicle speed rate of change error value. In a first example, the vehicle system includes wherein the vehicle speed rate of change error is based on a difference between output of a vehicle speed rate of change profile and an actual vehicle speed rate of change. In a second example that may include the first example, the vehicle system includes wherein the vehicle speed rate of change profile is a relationship between a vehicle speed rate of change and a driver demand pedal position. In a third example that may include one or both of the first and second examples, the vehicle system includes where the propulsion source is an electric machine. In a fourth example that may include one or more of the first through third examples, the vehicle system further comprises additional executable instructions that cause the controller to adjust an integral gain of the proportional/integral/derivative controller in response to a vehicle operating mode.

Referring now to FIG. 2A, a plurality of vehicle performance profiles are shown. The vehicle performance profiles describe a rate of vehicle speed change versus driver demand pedal position. The vehicle performance profiles may be referenced or indexed via driver demand pedal position to output a positive rate of vehicle speed change.

FIG. 2A shows three vehicle performance profiles. The first vehicle performance profile is indicated by dashed line trace 202 and it represents a sport vehicle performance profile. The second performance profile is indicated by dot-dash trace 204 and it represents a base or normal vehicle performance profile. The third performance profile is indicated by solid trace 206 and it represents an economy vehicle performance profile. In other examples, more than three vehicle performance profiles may be provided. The performance profiles of FIG. 2A apply when the propulsion source is being requested to provide positive propulsive effort.

Turning now to FIG. 2B, a plurality of vehicle performance braking profiles are shown. The vehicle performance braking profiles describe a rate of negative vehicle speed change (e.g., vehicle slowing) versus brake pedal position. The vehicle performance profiles may be referenced or indexed via brake pedal position to output a rate of negative vehicle speed change.

FIG. 2B shows three vehicle braking performance profiles. The first performance profile is indicated by solid trace 256 and it represents an economy vehicle performance braking profile where there may be a lower rate of vehicle speed reduction and less energy captured. The second performance profile is indicated by dot-dash trace 254 and it represents a base or normal vehicle performance braking profile where there may be a medium rate of vehicle speed reduction and a medium level of energy captured. The third vehicle performance braking profile is indicated by dashed line trace 252 and it represents a sport vehicle performance braking profile where there may be a greater rate of vehicle speed reduction and more energy captured. In other examples, more than three vehicle performance braking profiles may be provided. The performance profiles of FIG. 2B apply when the propulsion source is being requested to provide negative or braking torque to slow the vehicle.

Referring now to FIG. 3, vehicle speed according to a prior art control mode is shown. Dashed line trace 302 represents vehicle speed when driver demand follows a predetermined profile when a vehicle is loaded with 11,000 pounds. Dot-dash trace 304 represents vehicle speed when driver demand follows a predetermined profile when a vehicle is loaded with 17,000 pounds. Solid trace 306 represents vehicle speed when driver demand follows a predetermined profile when a vehicle is loaded with 23,000 pounds. Thus, it may be observed that vehicle speed increases slower for the vehicle that is loaded with 23,000 pounds. In this way, the performance of the vehicle that may be observed by the driver changes depending on the amount of load that is applied to the vehicle.

Moving on now to FIG. 4, vehicle speed according to the present method of control mode is shown. Dashed line trace 402 represents vehicle speed when driver demand follows a predetermined profile when a vehicle is loaded with 11,000 pounds. Dot-dash trace 404 represents vehicle speed when driver demand follows a predetermined profile when a vehicle is loaded with 17,000 pounds. Solid trace 406 represents vehicle speed when driver demand follows a predetermined profile when a vehicle is loaded with 23,000 pounds. Thus, it may be observed that vehicle speed increases nearly uniformly when each load is applied to the vehicle. Accordingly, the performance of the vehicle that may be observed by the driver may change less significantly according to the amount of load that is applied to the vehicle, so long as the vehicle is loaded within a particular load range.

Referring now to FIGS. 5 and 6, a flowchart of a method to control a vehicle is shown. The method may be at least partially implemented as executable instructions stored in controller memory (e.g., ROM) in the system of FIGS. 1-3. The method of FIGS. 5 and 6 may operate in cooperation with the system of FIG. 1. Further, the method may include actions taken in the physical world to transform an operating state of the system of FIG. 1. Additionally, the method may provide the operating sequence shown in FIG. 4.

At 502, method 500 may receive driver (e.g., the vehicle's user), manufacturer, or vehicle owner (e.g., end customer) vehicle performance profiles. In one example, vehicle performance profiles may be entered into a human/machine interface and then stored to controller memory (e.g., RAM). For example, a driver may input a vehicle performance profile as shown in FIG. 2A that includes level one (e.g., economy), level two (e.g., baseline), and level three (e.g., sport) vehicle performance profiles. The level one vehicle performance profile may provide reduced vehicle performance and decreased vehicle energy consumption by reducing a rate at which vehicle speed may increase. The level two vehicle performance profile may allow a user to increase vehicle speed at a rate that is greater than in the first level performance mode and the third level performance mode may allow the user to increase vehicle speed at a rate that is greater than a rate that vehicle speed may be increased in the second level performance mode. The driver, manufacturer, or vehicle owner may also select a vehicle performance profile to be engaged for vehicle control. Method 500 proceeds to 504.

At 504, method 500 judges whether or not vehicle performance profiles have been received from a driver, manufacturer, or vehicle owner. Method 500 may also determine whether or not one of the vehicle performance profiles has been selected to be engaged for controlling the vehicle. If method 500 judges that vehicle performance profiles have been received from a driver, manufacturer, or vehicle owner, the answer is yes and method 500 proceeds to 506. Otherwise, the answer is no and method 500 proceeds to 550.

At 550, method 500 requests torque from the vehicle's propulsion source according to a position of a driver demand pedal. In one example, the driver demand pedal position may be mapped to a specific torque amount and the propulsion source is requested to generate the requested torque amount. The driver demand may be transferred from one device or module to another via data over a network, hardwire connection, internal to a control module, or other means. Method 500 proceeds to exit.

At 506, method 500 loads the vehicle performance profile (e.g., curve 204 of FIG. 2A) that has been selected into controller memory (e.g., RAM). Additionally, method 500 may load proportional/integral/derivative (PID) control parameters that correspond to the selected vehicle performance profile into controller memory. For example, method 500 may include individual proportional gain Kp (e.g., scalar real numbers) values for each vehicle performance profile (e.g., economy, baseline, sport) that are loaded into controller memory. Likewise, method 500 may include individual integral gain Ki and derivative gain Kd values that that are loaded into controller memory. Method 500 proceeds to 508.

At 508, method 500 judges whether or not a driver has applied the driver demand pedal. If so, the answer is yes and method 500 proceeds to 510. If not, method 500 returns to 508.

At 510, method 500 activates the performance management controller (e.g., a PID, or PI controller as shown in FIG. 7). Activating the controller may include beginning to integrate an error value between a vehicle performance profile and an actual rate of vehicle speed change. Further, controller parameters may be engaged and the controller variables may begin to be updated. Method 500 proceeds to 512.

At 512, method 500 adjusts a driver torque demand so that the vehicle's present rate of speed change matches the speed change of the vehicle performance profile. The adjustment to the driver demand torque may be made via a PID controller as shown in FIG. 7. Method 500 adjusts the driver demand torque and commands the vehicle's propulsion source according to the adjusted driver demand torque as shown in FIG. 7. Method 500 proceeds to 514.

At 514, method 500 judges whether or not the vehicle's brake pedal is applied, the vehicle is in a regenerative braking mode, or if a system fault is present. If so, the answer is yes and method 500 proceeds to 516. Otherwise, the answer is no and method 500 proceeds to exit.

At 516, method 500 deactivates the vehicle performance controller and then proceeds to 518. Deactivating the vehicle performance controller may include but is not constrained to ceasing to integrate the error amount between the vehicle performance profile and the present rate of vehicle speed change. Method 500 may also suspend output of the PID controller. Method 500 proceeds to 518.

At 518, method 500 judges whether or not the vehicle's regeneration management is activated and if the vehicle is operating in a regeneration mode. If so, the answer is yes and method 500 proceeds to 520. Otherwise, the answer is no and method 500 proceeds to 560. The regeneration mode may be activated when the driver is not applying the driver demand pedal and/or when the vehicle brake pedal is applied.

At 560, method 500 requests a braking torque from the vehicle's propulsion source according to a position of a brake pedal. In one example, the brake pedal position may be mapped to a specific torque amount and the propulsion source is requested to generate the requested torque amount. Method 500 proceeds to exit.

At 520, method 500 may receive driver (e.g., the vehicle's user), manufacturer, or vehicle owner (e.g., end customer) vehicle performance braking profiles. In one example, vehicle performance braking profiles may be entered into a human/machine interface and then stored to controller memory (e.g., RAM). For example, a driver may input a vehicle performance braking profile as shown in FIG. 2B that includes first level, second level, and third level vehicle performance profiles. The first level vehicle performance braking profile may reduce the vehicle's rate of vehicle speed reduction and increase an amount of energy that is captured during braking. The second level vehicle performance braking profile may allow a user to decrease vehicle speed at a rate that is greater than in the first level vehicle performance braking profile and the third level vehicle performance braking profile may allow the user to decrease vehicle speed at a rate that is greater than a rate that vehicle speed may be decreased in the second level vehicle performance braking profile. The driver, manufacturer, or vehicle owner may also select a vehicle performance braking profile to be engaged for vehicle control. Method 500 proceeds to 522.

At 522, method 500 judges whether or not vehicle performance braking profiles have been received from a driver, manufacturer, or vehicle owner. Method 500 may also determine whether or not one of the vehicle performance braking profiles has been selected to be engaged for controlling the vehicle. If method 500 judges that vehicle performance braking profiles have been received from a driver, manufacturer, or vehicle owner, the answer is yes and method 500 proceeds to 524. Otherwise, the answer is no and method 500 proceeds to 570.

At 570, method 500 requests torque from the vehicle's propulsion source according to a position of a brake pedal and battery state of charge (SOC). In one example, the brake pedal position may be mapped to a specific regenerative braking torque amount and the propulsion source is requested to generate the requested braking torque amount. Method 500 proceeds to exit.

At 524, method 500 loads the vehicle performance braking profile (e.g., curve 254 of FIG. 2B) that has been selected into controller memory (e.g., RAM). Additionally, method 500 may load proportional/integral/derivative (PID) control parameters that correspond to the selected vehicle performance braking profile into controller memory. For example, method 500 may include individual proportional gain Kp (e.g., scalar real numbers) values for each vehicle performance braking profile (e.g., economy, baseline, sport) that are loaded into controller memory. Likewise, method 500 may include individual integral gain Ki and derivative gain Kd values that that are loaded into controller memory. Method 500 proceeds to 526.

At 526, method 500 judges whether or not a driver demand is greater than a threshold amount, if vehicle speed is greater than a threshold, or if a brake pedal is applied. If one of the conditions is present, the answer is yes and method 500 proceeds to 528. Otherwise, method 500 returns to 526.

At 528, method 500 activates the performance management regenerative braking controller (e.g., a PID, or PI controller as shown in FIG. 8). Activating the controller may include beginning to integrate an error value between a vehicle performance profile and an actual rate of vehicle speed change. Further, controller parameters may be engaged and the controller variables may begin to be updated. Method 500 proceeds to 530.

At 530, method 500 adjusts a driver braking torque demand so that the vehicle's present rate of speed change matches the speed change of the vehicle performance braking profile. The adjustment to the driver braking torque may be made via a PID controller as shown in FIG. 8. Method 500 adjusts the driver braking torque and commands the vehicle's propulsion source according to the adjusted driver braking torque as shown in FIG. 8. Method 500 proceeds to 532.

At 532, method 500 judges whether or not the driver demand (DD) brake pedal is applied or if a system fault is present. If so, the answer is yes and method 500 proceeds to 534. Otherwise, the answer is no and method 500 proceeds to exit.

At 534, method 500 deactivates the vehicle performance braking controller and then proceeds to 536. Deactivating the vehicle performance braking controller may include but is not constrained to ceasing to integrate the error amount between the vehicle performance braking profile and the present rate of vehicle speed change. Method 500 may also suspend output of the PID controller. Method 500 proceeds to 536.

At 536, method 500 judges whether or not the vehicle's regeneration braking management is activated and if the vehicle is operating in a regeneration mode. If so, the answer is yes and method 500 returns to 502. Otherwise, the answer is no and method 500 proceeds to 580. The regeneration braking mode may be activated when the driver is not applying the driver demand pedal and/or when the vehicle brake pedal is applied.

At 580, method 500 requests a braking torque from the vehicle's propulsion source according to a position of a brake pedal. In one example, the brake pedal position may be mapped to a specific torque amount and the propulsion source is requested to generate the requested torque amount. Method 500 proceeds to exit.

Thus, the method of FIG. 5 provides for a method for operating a vehicle, comprising: adjusting torque output of an electric machine via a controller in response a pedal position and a difference between a performance profile and a present rate of vehicle speed change. In a first example, the method includes wherein the pedal position is a brake pedal position. In a second example that may include the first example, the method includes wherein adjusting torque output of the electric machine via the controller in response to a pedal position includes generating a braking torque as a function of brake pedal position. In a third example that may include one or both of the first and second examples, the method includes wherein adjusting torque output of the electric machine via the controller in response to the difference between the performance profile and the present rate of vehicle speed change includes modifying the difference via proportional and integral gains. In a fourth example that may include one or both of the first through third examples, the method includes wherein the pedal position is a driver demand pedal position. In a fifth example that may include one or more of the first through fourth examples, the method includes wherein adjusting torque output of the electric machine via the controller in response to a pedal position includes generating a propulsion torque as a function of driver demand pedal position. In a sixth example that may include one or more of the first through fifth examples, the method includes wherein adjusting torque output of the electric machine via the controller in response to the difference between the performance profile and the present rate of vehicle speed change includes modifying the difference via proportional and integral gains.

Referring now to FIG. 7, a block diagram of a vehicle performance controller is shown. The block diagram may represent executable instructions that are stored in controller memory (e.g., ROM). The executable instructions of FIGS. 7 and 8 may operate in conjunction and cooperation with the method of FIGS. 5 and 6 and the system of FIG. 1. In addition, the instructions may include instructions to facilitate actions taken in the physical world to transform an operating state of the system of FIG. 1.

At block 702, driver demand pedal position and vehicle speed index or reference a table or function of empirically determined driver demand torque request values. The driver demand torque request values may be torque request values at a propulsion device, at a location in the driveline, or at a wheel. For example, for a particular pair of driver demand pedal position and vehicle speed, block 702 outputs an empirically determined requested driver demand torque value. Block 702 outputs a requested driver demand torque to summing junction 704. Summing junction 704 adds the output of block 702 (requested driver demand torque) and the output of block 730 (constrained torque adjustment value). The vehicle's propulsion device may be commanded to provide the output of summing junction 704.

Driver demand pedal position is input to reference or index tables or functions in blocks 750-754. A plurality of tables or functions in blocks 750-754 are included to provide different rates of vehicle speed increase as a function of driver demand pedal position as shown in FIG. 2A. Tables or functions in blocks 750-754 output a rate of vehicle speed increase according to a particular vehicle performance profile. For example, block 750 outputs an economy rate of vehicle speed increase, block 752 outputs a baseline rate of vehicle speed increase, and block 754 outputs a sport mode rate of vehicle speed increase.

Switching block 712 includes a switching control input that receives a value that represents a selected performance profile (e.g., 0=economy, 1=baseline, 2=sport) and switching block 712 directs the output of block 750, block 752, or block 754 to the output of switching block 712. The output of switching block 712 goes to junction 714. Thus, if switching block 712 determines that economy mode is selected, block 712 outputs the output of block 750 (e.g., an economy mode rate of vehicle speed increase) to an input of junction 714.

Gain select block 713 selects and individually outputs Ki (integral gain), Kp (proportional gain), and Kd derivative gain to blocks 716, 718, and 722 based on the vehicle performance profile that is selected. For example, if an integral gain value is 0.5, gain select block 713 delivers a value of 0.5 to block 716. Likewise, if a proportional gain is value is 2, gain select block 713 delivers a value of 2 to block 718. Gain select block 713 may include individual Ki, Kp, and Kd gains for each vehicle performance profile that may be selected (e.g., economy, baseline, sport). Accordingly, gain select block 713 outputs three values to three different gain blocks (716, 718, and 722).

At junction 714, an actual rate of vehicle speed change is subtracted from a requested rate of vehicle speed change that is determined from driver demand pedal position and the selected vehicle performance profile. The result of the subtraction is generation of a rate of vehicle speed change error. The rate of vehicle speed change error is input to blocks 716, 718, and 720.

At block 716, the rate of vehicle speed change error is numerically integrated and block 716 outputs the integrated rate of vehicle speed change error to block 717. The integral gain (e.g., scalar real number) at block 717 multiplies the integrated rate of vehicle speed change error and provides the result to junction 724.

At block 718, the rate of vehicle speed change error is multiplied by the proportional gain Kp and the result is delivered to junction 724.

At block 720, a derivative of the rate of vehicle speed change error is generated and block 720 outputs the differentiated rate of vehicle speed change error to block 722. The differential gain Kd (e.g., scalar real number) multiplies the differentiated rate of vehicle speed change error at block 722 and the result is provided to junction 724.

At junction 724, the output of blocks 717, 718, and 722 are added to generate an adjustment to the requested torque. The adjustment to the requested torque is output to block 730. Block 730 constrains the adjustment torque such that the adjustment torque is not permitted below a first threshold value nor is the adjustment torque permitted below a second threshold value. Block 730 outputs a constrained adjustment torque. The constrained adjustment torque is input to summing junction 704.

In this way, a difference between a performance profile value and a present rate of vehicle speed change may be applied to modify a requested torque. The requested torque may be driven by the adjustment to converge to a value that is output from a performance profile.

Referring now to FIG. 8, a block diagram of a vehicle performance controller is shown. The block diagram may represent executable instructions that are stored in controller memory (e.g., ROM). The executable instructions of FIGS. 7 and 8 may operate in conjunction and cooperation with the method of FIGS. 5 and 6 and the system of FIG. 1. In addition, the instructions may include instructions to facilitate actions taken in the physical world to transform an operating state of the system of FIG. 1.

At block 802, brake pedal position may index or reference a table or function of empirically determined braking torque request values. The braking torque request values may be torque request values at a propulsion device, at a location in the driveline, or at a wheel. Block 802 outputs a requested braking torque to summing junction 804. Summing junction 804 adds the output of block 830 (constrained requested braking torque) and the output of block 802. The vehicle's propulsion device may be commanded to provide the output of summing junction 804.

Brake pedal position is input to reference or index tables or functions in blocks 850-854. A plurality of tables or functions in blocks 850-854 are included to provide different rates of vehicle speed decrease as a function of driver demand pedal position as shown in FIG. 2B. Tables or functions in blocks 850-854 output a rate of vehicle speed decrease according to a particular vehicle performance profile. For example, block 850 outputs an economy rate of vehicle speed decrease, block 852 outputs a baseline rate of vehicle speed decrease, and block 854 outputs a sport mode rate of vehicle speed decrease.

Switching block 812 includes a switching control input that receives a value that represents a selected performance profile (e.g., 0=economy, 1=baseline, 2=sport) and switching block 812 directs the output of block 850, block 852, or block 854 to the output of switching block 812. The output of switching block 812 goes to junction 814. Thus, if switching block 812 determines that economy mode is selected, block 812 outputs the output of block 850 (e.g., an economy mode rate of vehicle speed increase) to an input of junction 814.

Gain select block 813 selects and individually outputs Ki (integral gain), Kp (proportional gain), and Kd derivative gain to blocks 816, 818, and 822 based on the vehicle performance profile that is selected. For example, if an integral gain value is 0.5, gain select block 813 delivers a value of 0.2 to block 816. Likewise, if a proportional gain is value is 3, gain select block 813 delivers a value of 3 to block 818. Gain select block 813 may include individual Ki, Kp, and Kd gains for each vehicle performance profile that may be selected (e.g., economy, baseline, sport). Accordingly, gain select block 813 outputs three values to three different gain blocks (816, 818, and 822).

At junction 814, an actual rate of vehicle speed change is subtracted from a requested rate of vehicle speed change that is determined from brake pedal position and the selected vehicle performance profile. The result of the subtraction generates of a rate of vehicle speed change error. The rate of vehicle speed change error is input to blocks 816, 818, and 820.

At block 816, the rate of vehicle speed change error is numerically integrated and block 816 outputs the integrated rate of vehicle speed change error to block 817. The integral gain Ki (e.g., scalar real number) multiplies the integrated rate of vehicle speed change error at block 817 and the result is delivered to junction 824.

At block 818, the rate of vehicle speed change error is multiplied by the proportional gain kp and the result is delivered to junction 824.

At block 820, a derivative of the rate of vehicle speed change error is generated and block 820 outputs the differentiated rate of vehicle speed change error to block 822. The differential gain Kd (e.g., scalar real number) multiplies the differentiated rate of vehicle speed change error at block 822 and the result is provided to junction 824.

At junction 824, the output of blocks 817, 818, and 822 are added to generate an adjustment to the requested braking torque. The adjustment to the requested braking torque is output to block 830. Block 830 constrains the adjustment braking torque such that the adjustment braking torque is not permitted below a first threshold value nor is the adjustment braking torque permitted below a second threshold value. Block 830 outputs a constrained adjustment braking torque. The constrained adjustment braking torque is input to summing junction 804.

In this way, a difference between a performance profile value and a present rate of vehicle speed change may be applied to modify a requested braking torque. The requested braking torque may be driven by the adjustment to converge to a value that is output from a performance profile.

Note that the example control and estimation routines included herein can be used with various powertrain and/or vehicle system configurations. The control methods and routines disclosed herein may be stored as executable instructions in non-transitory memory and may be carried out by the control system including the controller in combination with the various sensors, actuators, and other transmission and/or vehicle hardware. Further, portions of the methods may be physical actions taken in the real world to change a state of a device. Thus, the described actions, operations and/or functions may graphically represent code to be programmed into non-transitory memory of the computer readable storage medium in the vehicle and/or transmission control system. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. One or more of the method steps described herein may be omitted if desired.

While various embodiments have been described above, it is to be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of electric machines, internal combustion engines, and/or transmissions. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A vehicle system, comprising:
a propulsion source;
a driver demand pedal; and
a controller including executable instructions that cause the controller to adjust a torque request in response to a difference between output of one of a plurality of performance profiles and a present rate of vehicle speed change.

2. The vehicle system of claim 1, wherein the output of one of the plurality of performance profiles is a rate of vehicle speed change.

3. The vehicle system of claim 1, wherein a torque of the propulsion source is adjusted to meet the torque request, and where the propulsion source is an electric machine.

4. The vehicle system of claim 1, wherein the torque request is based on a position of the driver demand pedal.

5. The vehicle system of claim 1, wherein the torque request is adjusted via a proportional/integral/derivative controller.

6. The vehicle system of claim 5, further comprising additional instructions to adjust a proportional gain and an integral gain based on one of the plurality of performance profiles.

7. The vehicle system of claim 1, where the propulsion source is integrated in an axle.

8. The vehicle system of claim 1, where the plurality of performance profiles include an economy profile, a baseline profile, and a sport profile.

9. A method for operating a vehicle, comprising:
adjusting torque output of an electric machine via a controller in response a pedal position and a difference between a performance profile and a present rate of vehicle speed change.

10. The method of claim 9, wherein the pedal position is a brake pedal position.

11. The method of claim 10, wherein adjusting torque output of the electric machine via the controller in response to the pedal position includes generating a braking torque as a function of brake pedal position.

12. The method of claim 11, wherein adjusting torque output of the electric machine via the controller in response to the difference between the performance profile and the present rate of vehicle speed change includes modifying the difference via proportional and integral gains.

13. The method of claim 9, wherein the pedal position is a driver demand pedal position.

14. The method of claim 13, wherein adjusting torque output of the electric machine via the controller in response to the pedal position includes generating a propulsion torque as a function of driver demand pedal position.

15. The method of claim 14, wherein adjusting torque output of the electric machine via the controller in response to the difference between the performance profile and the present rate of vehicle speed change includes modifying the difference via proportional and integral gains.

16. A vehicle system, comprising:
a propulsion source;
a driver demand pedal; and
a controller including executable instructions that cause the controller to adjust a driver demand torque delivered by the propulsion source according to a correction output by a proportional/integral/derivative controller that responds to a vehicle speed rate of change error value.

17. The vehicle system of claim 16, wherein the vehicle speed rate of change error is based on a difference between output of a vehicle speed rate of change profile and an actual vehicle speed rate of change.

18. The vehicle system of claim 17, wherein the vehicle speed rate of change profile is a relationship between a vehicle speed rate of change and a driver demand pedal position.

19. The vehicle system of claim 16, where the propulsion source is an electric machine.

20. The vehicle system of claim 16, further comprising additional executable instructions that cause the controller to adjust an integral gain of the proportional/integral/derivative controller in response to a vehicle operating mode.
